(19) United States
(12) Patent Application Publication
(10) Pub. No.: US 2008/0312065 A1
(43) Pub. Date: Dec. 18, 2008

(54) Highly Filled Dispersions Containing Aluminium Oxide

(75) Inventors: Monika Oswald, Hanau (DE); Corinna Kissner, Hanau (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA GMBH, ESSEN (DE)

(21) Appl. No.: 12/096,644

(22) PCT Filed: Dec. 5, 2006
(86) PCT No.: PCT/EP2006/069306

§ 371 Date: Jun. 9, 2008

(30) Foreign Application Priority Data
Dec. 15, 2005 (DE) 102005059961.3

(51) Int. Cl. C04B 35/10; C04B 35/46; C04B 35/48; C04B 35/50

(52) U.S. Cl. 501/134; 501/152; 501/153; 501/154

(57) ABSTRACT

Aqueous dispersion containing:
at least one metal oxide selected from the group consisting of alpha-aluminium oxide, cerium oxide, silicon dioxide, titanium dioxide and zirconium dioxide and in addition at least one transition aluminium oxide which is present in the form of aggregates of primary particles, wherein
   the total content of metal oxide and transition aluminium oxide is from 60 to 75% by weight, based on the total amount of the dispersion,
   the content of transition aluminium oxide is from 30 to 45% by weight, based on the total amount of the dispersion,
   the BET surface area of the transition aluminium oxide is from 30 to 90 m²/g,
   the mean aggregate diameter of the transition aluminium oxide is less than 100 nm,
   the mean particle diameter of the metal oxide is from 100 to 500 nm, and
a dispersant selected from the group consisting of polyaluminium hydroxychloride, polyaluminium hydroxynitrate and/or polyaluminium hydroxysulphate.

The invention relates to a dispersion containing transition aluminium oxide and a metal oxide, its production and use.

It is known that ceramic bodies can be produced by means of highly filled metal oxide dispersions. The requirements which the dispersion has to meet comprise mainly a low viscosity and a high degree of fill in order to minimize shrinkage and cracks in thermal treatment steps. It is also known that a high degree of fill can be achieved by means of a bimodal distribution of the particle sizes in which the gaps between the coarse particles are filled by finer particles.

Shi and Zhang, Journal of the American Ceramic Society 83 (2000), 737, disclose a bimodal aluminium oxide dispersion using aluminium oxide powders having a particle diameter determined by transmission electron microscopy of 0.17, 0.37 and 0.86 μm. The dispersions are obtained by stirring two of these powders into water and subsequently setting the pH. The optimal proportion of an in each case finer aluminium oxide is about 30%, based on the sum of coarse and fine aluminium oxide, in order to obtain a still processible dispersion and a substantially dense green body. According to Shi and Zhang, the total aluminium oxide content can be up to 45% by volume. However, the sintering activity of the aluminium oxides remains in need of improvement.

Smith and Haber, Journal of the American Ceramic Society 78 (1995), 1737, disclose bimodal dispersions of aluminium oxide using an aluminium oxide powder having a mean particle size of more than 1 μm (85 parts) and one having a mean particle size of 0.4 μm (15 parts) and having a content of up to 50% by volume. Here too, the sintering activity of the aluminium oxides remains in need of improvement.

It is an object of the invention to provide a highly filled, low-viscosity dispersion containing aluminium oxide which has a high sintering activity on thermal treatment.

The invention provides an aqueous dispersion containing:
at least one metal oxide selected from the group consisting of alpha-aluminium oxide, cerium oxide, silicon dioxide, titanium dioxide and zirconium dioxide and in addition at least one transition aluminium oxide which is present in the form of aggregates of primary particles, wherein
   the total content of metal oxide and transition aluminium oxide is from 60 to 75% by weight, based on the total amount of the dispersion,
   the content of transition aluminium oxide is from 30 to 45% by weight, based on the total amount of the dispersion,
   the BET surface area of the transition aluminium oxide is from 30 to 90 m²/g,
   the mean aggregate diameter of the transition aluminium oxide is less than 100 nm,
   the mean particle diameter of the metal oxide is from 100 to 500 nm, and
a dispersant selected from the group consisting of polyaluminium hydroxychloride, polyaluminium hydroxynitrate and/or polyaluminium hydroxysulphate.

The term metal oxide is to be interpreted as excluding transition aluminium oxides and including silicon dioxide as metalloid oxide.

The transition aluminium oxide present in the transition aluminium oxide dispersion includes chi-, kappa-, gamma-, delta- and theta-aluminium oxide. Apart from these crystalline constituents, small proportions of amorphous aluminium oxide can also be present. The dispersion contains only transition aluminium oxide as solid. The main constituent is preferably gamma-aluminium oxide, delta-aluminium oxide, theta-aluminium oxide or a mixture thereof. The transition aluminium oxide particularly preferably comprises at least 60% of a mixture of delta-aluminium oxide and theta-aluminium oxide. Alpha-aluminium oxide cannot be detected. The transition aluminium oxide is present in the form of aggregates of primary particles and has a BET surface area of from 30 to 90 m²/g, preferably from 40 to 80 m²/g and particularly preferably from 55 to 70 m²/g.

The transition aluminium oxide can preferably be obtained by a pyrogenic process. Such a process can be flame hydrolysis and/or flame oxidation. Here, organic or inorganic aluminium compounds, for example aluminium chloride, are reacted in the presence of steam and/or oxygen to form aluminium oxide. The resulting primary particles are not porous and have hydroxyl groups on their surface. In the case of a chloride-containing aluminium compound as starting material, the aluminium oxide can also contain small amounts of chloride, in general less than 0.1% by weight. The transition aluminium oxide dispersion is preferably produced using an aluminium oxide containing less than 300 ppm of chloride.

The total content of metal oxide and transition aluminium oxide is preferably from 63 to 70% by weight, based on the total amount of mixed oxide dispersion.

The content of transition aluminium oxide in the mixed oxide dispersion is preferably from 35 to 40% by weight, based on the total amount of the dispersion.

The mean particle diameter of the metal oxide is from 100 to 500 nm and thus greater than that of the transition aluminium oxide. The particle diameter of the metal oxide is preferably from 200 to 400 nm. The metal oxide particles can be present in the form of aggregated or unaggregated particles.

The metal oxide is preferably alpha-aluminium oxide, which usually has a BET surface area of from 5 to 20 m²/g.

The mixed oxide dispersion preferably has a pH of from 3 to 5.

The invention further provides a process for producing the dispersion of the invention, in which
the metal oxide in the form of a powder having a mean particle diameter of from 100 to 500 nm is added with agitation to
the transition aluminium oxide in the form of a starting dispersion
   which contains transition aluminium oxide as only solid,
   in which the aluminium oxide is present in the form of aggregates of primary particles which have a BET surface area of from 30 to 90 m²/g and whose aggregates in the dispersion have a mean aggregate diameter of less than 100 nm,
   whose content of aluminium oxide is from 40 to 65% by weight,
   which contains polyaluminium hydroxychloride, polyaluminium hydroxynitrate and/or polyaluminium hydroxysulphate as dispersant and
   which has a pH of from 3 to 5.

The aqueous dispersion which contains exclusively transition aluminium oxide as solid will hereinafter be referred to as transition aluminium oxide dispersion.

The mean aggregate diameter of the transition aluminium oxide dispersion is preferably from 70 to 90 nm. The mean aggregate diameter can be determined, for example, by laser light scattering.

Furthermore, the pH of the transition aluminium oxide dispersion can preferably be from 3.5 to 4.5. The pH can be adjusted by addition of pH regulators, acids or bases. If aluminium chlorides are used as starting material for preparing aluminium oxide, the pH can already be in the desired pH range as a result of adhering hydrochloric acid.

The dispersion of the invention contains a polyaluminium hydroxychloride (PAC), polyaluminium hydroxynitrate and/or polyaluminium hydroxysulphate as significant constituent, with the dispersion preferably containing polyaluminium hydroxychloride (PAC). This is a water-soluble salt of the formula Alₙ(OH)ₘCl₍₃ₙ₋ₘ₎, for example Al₂(OH)_{2.6}Cl_{3.4}. The PAC preferably has an aluminium content of from 5 to 25% by weight, calculated as Al₂O₃.

A mixture of PAC with a cationic polymer and/or a cocondensation product of PAC and a cationic dicyandiamide resin has been found to be a particularly advantageous dispersant.

As cationic polymers, preference is given to using polyethylenimines, polydiallyldimethylammonium chlorides or cationic dicyandiamide resins.

The cationic dicyandiamide resins and their preparation are described, for example, in DE-A-3500408. The polyaluminium hydroxychloride and the cationic polymer are preferably present in a weight ratio of from 30:70 to 95:5.

The proportion of dispersant is preferably from 0.1 to 3% by weight, based on the total amount of the dispersion.

Furthermore, the dispersion of the invention can contain a cocondensation product of polyaluminium hydroxychloride and a cationic dicyandiamide resin as constituent. These cocondensation products and their preparation are known from DE-A-3742764. The ratio of PAC to cationic dicyandiamide resin in this cocondensation product can likewise be varied within wide limits, but a molar ratio of aluminium to dicyandiamide of from 15:1 to 2:1 is preferred.

Compounds of the general formula A in which R═CONH₂, CN or H; X═Cl⁻, ½SO₄²⁻ and n=5-15 are particularly suitable as constituents of the dispersion of the invention.

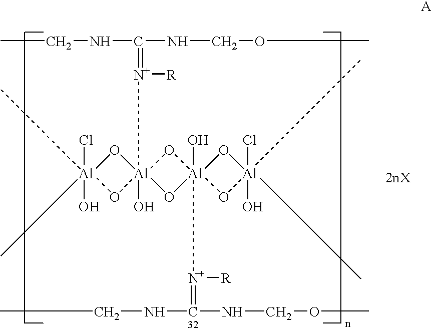

The transition aluminium oxide dispersion can be obtained by, if appropriate, placing one or more additives in water, adding aluminium oxide powder all at once, in portions or continuously and dispersing the mixture by introduction of energy of more than 1000 kJ/m³.

The process can preferably be carried out with dispersion firstly being carried out at an energy input of less than 1000 kJ/m³ to form a predispersion, dividing the predispersion into at least two substreams, placing these substreams under a pressure of at least 500 bar in a high-energy mill, depressurizing via a nozzle and allowing the substreams to impinge on one another in a gas- or liquid-filled reaction space and, if appropriate, repeating the high-energy milling one or more times.

The invention further provides for the use of the mixed oxide dispersion for producing composites.

### EXAMPLES

### Transition Aluminium Oxide Dispersion

### Example 1

### According to the Invention

37 kg of deionized water and 460 g of ALZOFIX® P9 (a PAC-dicyandiamide cocondensation product, Degussa AG) are placed in a 60 l stainless steel mixing vessel. 25 kg of AEROXIDE® Alu 65 (pyrogenic aluminium oxide, BET=65 m²/g, main constituents: theta- and delta-aluminium oxide; Degussa AG) are subsequently sucked in under shear conditions by means of an Ystral Conti-TDS 3 suction hose (stator slits: 4 mm ring and 1 mm ring, rotor/stator spacing about 1 mm). A further 340 g of ALZOFIX are then added and 5 kg of AEROXIDE® Alu 65 are sucked in. This alternating addition is carried out a total of 6 times. After the addition is complete, the intake port is closed and shear is applied at 3000 rpm for another 20 minutes. Finally, the predispersion is brought to a content of 55% by weight by means of 5.5 kg of deionized water and sheared once more for a further period of about 5 minutes to homogenize it. This predispersion is passed through a Sugino Ultimaizer HJP-25050 high-energy mill having diamond nozzles having a diameter of 0.3 mm at a pressure of 2500 bar in two passes and thereby subjected to further intensive milling.

The pH is 4.1. The solids content of the dispersion is 55% by weight. The mean aggregate diameter is 83 nm (determined by means of a Horiba LA-910). The dispersion displays no signs of gelling or sedimentation even after 6 months.

### Example 2

### Comparative Example

61 kg of deionized water are placed in a 60 l stainless steel mixing vessel. 27.0 kg of AEROXIDE® Alu C (BET=100 m²/g, main constituent: gamma-aluminium oxide) Degussa are subsequently sucked in under shear conditions by means of an Ystral Conti-TDS 3 suction hose (stator slits: 4 mm ring and 1 mm ring, rotor/stator spacing about 1 mm). The pH is maintained in the range from 4.0 to 4.5 by addition of 50% strength acetic acid. 0.9 kg of 50% strength acetic acid are required. After drawing-in is complete, the intake port is closed and shear is applied at 3000 rpm for another 10 minutes. The pH after predispersion is 4.1 and was adjusted to 4.0 by means of a further 0.1 kg of acetic acid, the predispersion was brought to an aluminium oxide concentration of 30% by weight by addition of 1 kg of deionized water and sheared once more for a further period of about 5 minutes to homogenize it. This predispersion is passed through a Sugino Ultimaizer HJP-25050 high-energy mill having diamond nozzles having a diameter of 0.3 mm at a pressure of 2500 bar in two passes and thereby subjected to further intensive milling.

The pH is 4.4. The solids content of the dispersion is 30% by weight. The mean aggregate diameter is 86 nm (Horiba LA-910).

### Mixed Oxide Dispersion

### Example 3

550 g of the dispersion from Example 1 are placed in a vessel. While stirring by means of a laboratory stirrer, 155 g of alpha-aluminium oxide powder (AKP-50, Sumitomo, mean particle size about 200 nm) are added.

### Examples 4 and 5

analogous to Example 3 but using the amounts indicated in Table 1.

### Example 6

analogous to Example 3 but using the dispersion from Example 2.

The dispersion from Example 5 has a viscosity of 1000 mPas at 23° C. and a shear rate of 100 s⁻¹.

The mixed oxide dispersion has a proportion of finely divided transition aluminium oxide of at least 30% by weight, based on the total amount of the dispersion. Based on the total solids, the proportion of finely divided transition aluminium oxide is at least 40%. The mixed oxide dispersion can be produced by simple stirring of the metal oxide into the transition aluminium oxide dispersion.

TABLE 1
Starting materials for producing the mixed oxide
dispersions

| Example | | 3 | 4 | 5 | 6 |
|---|---|---|---|---|---|
| Transition | | 1 | 1 | 1 | 2 |
| Al₂O₃ | | | | | |
| dispersion from | | | | | |
| Example | | | | | |
| Amount of | g | 550 | 550 | 550 | 400 |
| dispersion | | | | | |
| of which | g | 302.5 | 302.5 | 302.5 | 120 |
| transition | | | | | |
| Al₂O₃ | | | | | |
| conc. of | % by | 55 | 55 | 55 | 30 |
| transition | weight | | | | |
| Al₂O₃ | | | | | |
| +alpha-Al₂O₃ | g | 155 | 247.3 | 315.3 | 111 |
| +hydrochloric | g | — | 29.3 | 29.3 | — |
| acid (1 M) | | | | | |
| Total amount | g | 705 | 826.6 | 894.6 | 511 |
| of mixed oxide | | | | | |
| dispersion | | | | | |
| Conc. of | % by | 43 | 37 | 34 | 23 |
| transition | weight | | | | |
| Al₂O₃ | | | | | |
| Conc. of | % by | 22 | 30 | 35 | 22 |
| alpha-Al₂O₃ | weight | | | | |
| Conc. of total | % by | 65 | 67 | 69 | 45 |
| Al₂O₃ | weight | | | | |
| pH | | 4.03 | 3.35 | 3.58 | 4.59 |
| Observation | | readily | readily | readily | not |
| | | pourable | pourable | pourable | pourable, |
| | | | | | lumpy |

1: An aqueous dispersion comprising:
at least one metal oxide selected from the group consisting of alpha-aluminium oxide, cerium oxide, silicon dioxide, titanium dioxide and zirconium dioxides and in addition at least one transition aluminium oxide which is present in the form of aggregates of primary particles, wherein
the total content of metal oxide and transition aluminium oxide is from 60 to 75% by weight, based on the total amount of the dispersion,
the content of transition aluminium oxide is from 30 to 45% by weight, based on the total amount of the dispersion,
the BET surface area of the transition aluminium oxide is from 30 to 90 m²/g,
the mean aggregate diameter of the transition aluminium oxide is less than 100 nm,
the mean particle diameter of the metal oxide is from 100 to 500 nm, and
at least one dispersant selected from the group consisting of polyaluminium hydroxychloride, polyaluminium hydroxynitrate and polyaluminium hydroxysulphate.

2: The aqueous dispersion according to claim 1, wherein the total content of metal oxide and transition aluminium oxide is from 63 to 70% by weight, based on the total amount of the dispersion.

3: The aqueous dispersion according to claim 1, wherein the content of transition aluminium oxide is from 35 to 40% by weight, based on the total amount of the dispersion.

4: The aqueous dispersion according to claim 1, wherein the transition aluminium oxide comprises theta- and delta-aluminium oxide as a main constituent.

5: The aqueous dispersion according to claim 1, wherein the BET surface area of the transition aluminium oxide is from 50 to 80 m²/g.

6: The aqueous dispersion according to claim 1, wherein the mean particle diameter of the metal oxide is from 150 to 250 nm.

7: The aqueous dispersion according to claim 1, wherein the metal oxide is alpha-aluminium oxide.

8: The aqueous dispersion according to claim 1, having a pH from 3 to 5.

9: The aqueous dispersion according to claim 1, wherein the dispersant is polyaluminium hydroxychloride, a mixture of polyaluminium hydroxychloride and a cationic polymer and/or a cocondensation product of polyaluminium hydroxychloride and a cationic dicyandiamide resin.

10: The aqueous dispersion according to claim 1, wherein the proportion of dispersant is from 0.1 to 3% by weight, based on the total amount of the dispersion.

11: A process for producing the aqueous dispersion according to claim 1, comprising:
adding, with agitation,
the at least one metal oxide in the form of a powder having a mean particle diameter of from 100 to 500 nm, and
the at least one transition aluminium oxide in the form of a starting dispersion wherein
the at least one transition aluminium oxide is the only solid,
the at least one transition aluminium oxide is present in the form of aggregates of primary particles which have a BET surface area of from 30 to 90 m²/g and whose aggregates in the dispersion have a mean aggregate diameter of less than 100 nm,
the content of aluminium oxide is from 40 to 65% by weight, and
the aqueous dispersion has a pH of from 3 to 5.

12: A composite comprising the aqueous dispersion according to claim 1.
